(19) United States
(12) Patent Application Publication
(10) Pub. No.: US 2024/0077097 A1
(43) Pub. Date: Mar. 7, 2024

(54) DAMPING ARRANGEMENT, COMPONENT WITH DAMPING ARRANGEMENT, CORRESPONDING COMPONENT CONNECTION, CONNECTING METHOD AND PRODUCTION METHOD

(71) Applicant: BÖLLHOFF VERBINDUNGSTECHNIK GmbH, Bielefeld (DE)

(72) Inventors: Jakob Klassen, Kalletal (DE); Heinrich Heinrichs, Vlotho (DE)

(21) Appl. No.: 18/140,017

(22) Filed: Apr. 27, 2023

(30) Foreign Application Priority Data
Apr. 27, 2022 (DE) DE102022110271.8

(51) Int. Cl. F16B 5/02; F16B 43/00

(52) U.S. Cl. CPC F16B 5/0258; F16B 43/00

(57) ABSTRACT

A damping arrangement which is fastenable in an opening of a first component and by which a dampened connection of the first component with a second component are realizable. The damping arrangement comprises two structurally identical damping elements, wherein each damping element including a head portion with a first outer diameter, a shaft portion with a second outer diameter that is smaller than the first outer diameter and extends from an underside of the head portion, as well as a central first through opening that is arranged within the shaft portion. The shaft portion comprises a circumferential wall with a plurality of apertures so that the two structurally identical damping elements are fastenable to one another via the shaft portion by means of a form fit and/or friction fit connection wherein the undersides of the head portion are arranged facing each other and with the first component arranged therebetween.

### CROSS REFERENCE TO RELATED APPLICATIONS

This application claims the priority to German Patent Application No. DE102022110271.8 filed on Apr. 27, 2022, and the content of this priority application is incorporated herein by reference in its entirety.

### TECHNICAL FIELD

The present disclosure is related to a damping arrangement consisting of two structurally identical damping elements, each having a central first through opening, a first component with a damping arrangement as well as a component connection by means of a damping arrangement. Furthermore, the present disclosure relates to a corresponding connecting method as well as a production method.

### BACKGROUND

Fastening arrangements with damping elements for fastening two components to each other, having a damping effect due to the damping elements, are generally known in the state of the art. Such fastening arrangements are generally arranged in a component opening of a first component and secured on both sides of the component opening. A connecting screw which is plugged through the fastening arrangement serves for fastening the first component to a second component.

For fastening the fastening arrangement in the component opening of the first component, traditionally, two differently configured fastening devices are used, each of which is arranged on a component side. Therefore, the fastening arrangement correspondingly comprises interacting securing elements, damping elements, sleeves and the like on each component side.

A mounting device for physically connecting a device or electrical panel having a mounting structure is for example described in US 2012/0049425 A1. The mounting devices provides a shock and force isolation. The mounting device comprises an inner and an outer portion mechanically connected via flexible shock absorbing structures. The outer part of the mounting device is mechanically connected to a fastening structure via removable connecting means. A device or an electrical plate is attached via mounting means to the center portion of the mounting device.

US 2017/0207615 A1 relates to a cable guide assembly which is configured to support media cables. The cable guide assembly comprises fastening features/structures which are configured and dimensioned in a way that they are releasably mountable with respect to a supporting structure.

A fastening device for fastening a decoupling device with respect to a hole rim of a hole opening of a shielding part is described in DE 10 2016 106 152 A1. The decoupling device for the vibration-decoupling connection of a sleeve with the shielding part includes at least one bridge element comprising at its outer radial rim connecting means for the fastening connection of the bridge element with the hole rim of the shielding part. The connecting means comprise at least four tabs which, starting from the bridge element, protrude radially outward. A subset of at least two tabs of the bridge element is provided to rest against a first outside of the shielding part and a remainder of at least two tabs is provided to rest against an opposite second outside of the shielding part. The hole rim with the tabs of the subset and the tabs of the remainder is fixable with respect to the decoupling device by means of a clamping fit.

DE 60 2004 002 062 T2 describes a vibration proofing heat shield fixed to a vibration source such as to cover at least a part of a heat source. Furthermore, it forms a gap with respect to a surface of said heat source so as to reduce a heat radiation from the heat source. The heat shield comprises a vibration proofing heat shield plate main body portion, a collar member, a washer as well as a joint member.

A cord connector which both seals and provides strain relief automatically upon wire insertion is described in US 2007/0026735 A1. The cord connector comprises a wire passageway through a pliable shell which seals around both the wire inserted through the passageway as well as the wall opening into which the plug is fastened. A more rigid skeleton supports this sleeve and is provided with appendages which permit the wire to pass through the passageway but which block any removal of the wire from the passageway.

EP 2 105 617 A2 describes a two-part fastening arrangement for a surface element that is composed of a base element and a coupling element. The base element is configured two-sided with a fastening surface on its first side and a connecting pin projecting from its second side, with which a snap connection to the coupling element can be produced. The coupling element is also configured two-sided with a fastening surface on its first side and a pin receiver for the connecting pin of the base element on its second side while the coupling element has an opening in which the pin receiver is resiliently arranged.

A sealing grommet out of plastic material for use on metal bolts in wall construction for protecting wires, cabling, conduit and the like is described in U.S. Pat. No. 5,537,714 A. The sealing grommet comprises a cylindrical body with an enlarged flange on one end with radially projecting spring snaps on the exterior of the body whereby the sealing grommet may be inserted into a hole having the size of the web with the hole edge captured between the snaps and flange. On the other side of the flange, there are diametrically opposed axially projecting spring fingers. The flange also has two diametrically opposed holes, the fingers and holes being positioned so that two sealing grommets may be joined flange-to-flange by axially rotating one with respect to the other.

U.S. Pat. No. 4,656,689 A also relates to a sealing grommet for protecting conduit passing through a wall opening and for providing an air sealing between the conduit and the edge of the wall around the wall opening. The sealing grommet has a stiff fastener portion with projections extending therefrom and locking devices at the ends of the projections in order to engage the edges of the wall around the wall opening. An elastomeric seal portion receives the projections and has an aperture of smaller dimensions than the outside dimensions of the conduit.

A method for forming a thru-hole through a compound structure with a plurality of internal compartments is described in U.S. Pat. No. 8,409,395 B2. An insert ring is connected with the composite structure to create a protective layer around the periphery of a penetration formed within the composite structure. An adhesive is disposed between the composite structure and the insert ring so as to create a fluid-tight seal between the insert ring and the internal compartments.

Finally, DE 10 2017 122 236 A1 describes a fastening system for fastening a component on a carrier component. The fastening system comprises a fastening bolt which can be fitted through a component through-passage and can be fastened in a fastening bore of the carrier component, and includes an outer sleeve and an inner sleeve which is mounted in an axially movable manner in a through-passage of the outer sleeve, wherein the inner sleeve forms a through-passage for the fastening bolt, the fastening bolt mounted in an axially movable manner in said through-passage opening for the fastening bolt. Furthermore, the fastening system includes a spring washer which can be fitted onto the outer sleeve, which is configured to position itself against a first side of the component when fastened, and a second spring washer which can also be fitted onto the outer sleeve, and is configured to position itself against a second side of the component when fastened, said second side being located opposite the first side.

A disadvantage of the known arrangements is the effort in terms of assembly and production as well as the lacking damping effect for both axial as well as radial vibrations.

A vibration absorber is described in DE 10 2019 107 885 A1. The vibration also comprises an absorber mass with an opening and at least two spring devices which are inserted into the opening. Each spring device comprises at least one elastomeric spring element and a supporting body wherein the supporting body accommodates the spring element. The supporting body includes an insertion section for inserting the supporting body and the spring element into the opening, wherein the insertion portion is inclined relative to a longitudinal axis of the vibration absorber.

A further vibration absorber is described in DE 10 2019 104 386 A1. This vibration absorber for absorbing and/or damping vibrations of a vehicle part comprises at least one mass element, at least one fastening element for fastening the vibration absorber to the vehicle part, at least one spring device and at least one securing device which captively connects the mass element and the fastening element to one another. The spring device is designed as at least one elastomeric shaped part that is produced separately from the mass element and the fastening element. The securing device receives the elastomeric shaped part in order to form at least one elastic bearing unit which elastically decouples the mass element from the fastening element.

A vibration absorber, which is also referred to as absorber or absorber pendulum, is a specific kind of a vibration absorber, because vibration absorbers are not fastened between two objects or components but to one component, only. In this context, the inherent frequency of the absorber is adapted to the resonance frequency of the component to be eliminated so that at this frequency, the component only performs slight movements. In contrast to that, the amplitude of the component below and above this frequency is greater than without absorber mass. Accordingly, no dampened connection of the first component with a second component can be realized with the vibration absorber, so that these documents cannot give any incentive as to a corresponding damping arrangement.

A vehicle body mount assembly with a first and a second retention, defining a core structure having replaceable elastomeric bodies thereon, is described in US 2006/244188. A mounting plate is provided between the elastomeric bodies for securing the assembly to a vehicle frame. A retaining clip assists in holding the assembly in the frame while fastener elements are affixed to the frame.

A further device for connecting two components is described in DE 199 16 098 A1. The device comprises a two-part elastic decoupling element which penetrates a receiving bore provided in the one component and receives the component between the parts of its elements, and a connecting means penetrating the decoupling element, which may be positioned in the other component and tightly clamps the decoupling element to the other component.

A damping bearing is known from DE 10 2005 010 433 A1. The damping bearing serves for the vibration and sound decoupled fastening of a sheet metal part. The damping bearing is comprised of two bearing parts which are essentially made of elastomeric materials, holding the sheet metal part in the region of a through opening and being permeated by a fastening means. For improving such a damping bearing with respect to the position-safe fastening of the components and the diversity of parts, the damping bearing comprises two bearing parts which are identical in construction, wherein in the portion between penetration opening and radial support along the circumference, the same include at least one tooth and tooth engagement recesses which have opposing surfaces congruent to the tooth and of the same amount with respect to the amount of the teeth arranged at the circumference beside this tooth or these teeth.

A mounting system for an electronic control module is described in U.S. Pat. No. 9,771,030 B1. The fastening system comprises a first fastening member, a second fastening member and a third fastening member, coupled to the first fastening member and the second fastening member by a plurality of first isolation devices and by a plurality of first fastening members. The third mounting element comprises a base portion having a first end and a second end. The base portion is coupled to the electronic control module by at least one second isolation device and by at least one second fastening member. The third fastening member comprises a first leg portion that is coupled to the first fastening member. The third fastening member further includes a second leg portion coupled to the second fastening member.

U.S. Pat. No. 4,530,491 A describes a damping arrangement. Here, axial loads and motions upon a unitary body of elastomer of the mount cause a compressive deflection and bi-directional bulging of a first ring-like portion of the body and a shear of deflection of a second, tubular portion of the body. The second portion of the body also imparts lateral stability to the mount.

A bushing assembly for use in a hinge for an automotive vehicle seat assembly is described in U.S. Pat. No. 4,883,319 A and comprises a pair of identical interlocking sleeves, each having a pair of opposing tangs extending in an axial direction from an annular portion. Each tang portion has a shoulder which is radially outwardly directed and is deflectable. The shoulders on the tang portions engage corresponding recessed ledges on the interior wall of the annular portion of the opposite sleeve so as to snap fit together to form an integrated bushing assembly through which a hinge pin is passed.

US 2010/0086377 A1 describes a vibration isolation fastener insert structure adapted to be partially or wholly snugly received in a hole in a panel. The fastener insert structure includes a rigid cylindrical hub having an externally extending flange and a through longitudinal opening adapted to receive a fastener element as well as an elastomeric bushing snugly carried or formed around said hub and having a slot therein receiving said external flange. Furthermore, the structure includes an upper housing and a lower housing.

A shock absorber is known from CN 111140612 A which comprises a connecting plate, a connecting bolt, a first shock absorbing arrangement and a second shock absorbing arrangement. The first shock absorbing arrangement includes a first sleeve and a first shock absorbing part covering the first sleeve. The second shock absorbing arrangement comprises a second sleeve and a second shock absorbing part covering the second sleeve. The connecting bolt passes through the first sleeve, the second sleeve and the connecting plate one after the other.

EP 2 980 437 A1 describes a vibration damping fastening system having a thread bolt with a bolt head, a housing with a bore hole for the form-fit fastening of the thread bolt, a flange with a passage, that is coaxial with respect to the bore hole, for the thread bolt, and elastic elements between the flange and the housing and/or between the thread bolt with the bolt head and the flange. The elastic elements contain full metal pillows.

A bracket mounting structure for mounting a bracket is described in U.S. Pat. No. 7,185,873 B2, which holds a center bearing of a propeller shaft to a vehicle body member by bolts and nuts. The structure contains a bush collar formed in a cylindrical shape having a flange in an upper end, fitted to the vehicle body member and fixed to the vehicle body member by the bolts and the nuts. The structure also contains a pair of upper and lower rubber bushes fitted to an outer periphery of the bush collar and gripping the bracket there-between, and a washer provided in a lower end of the lower rubber bush. An outer peripheral edge of a lower end of the bush collar extends all through an inner peripheral edge of the washer and is expanded outward in diameter.

JP 2014-095441 A1 suggests a vibration control bush comprising an inner cylinder part that is formed of metal and into which a column part of a screw is inserted, an outer cylinder part being formed by using rubber and being fastened to an outer surface of the inner cylinder part, and a washer part that is fastened to a surface opposite to the head portion of the screw of the outer cylinder part. A groove part into which a retainer is inserted is provided at an outer surface of the outer cylinder part in circumferential direction. When fastening a screw, the outer cylinder part is compressed, with the head part of the screw and a fitted body with the washer part interposed, and the side faces of the groove part come into contact with both surfaces of the bracket.

Finally, a method of attaching a vibration floating washer with a sleeve to a heat insulating plate including an insertion hole for the fastening screw is known from EP 1 054 386 A2. The method comprises arranging the metallic damping element on an inner side and a peripheral edge portion of the insertion hole for the fastening screw, inserting a male sleeve of a male washer and a female sleeve of a female washer, respectively, into the bolt insertion hole from both sides of the heat insulating plate as well as fitting and fixing the male washer and the female washer to each other with a fastening portion provided on the male sleeve and/or the female sleeve so that the heat insulating plate is maintained in a state of noncontact with both the male washer and the female washer.

Another fastening arrangement with damping effect as well as a component connection with the fastening arrangement is described in DE 10 2019 111 078 A1. The fastening arrangement with damping effect is made of two structurally identical fastening units each having a central first through opening. Each fastening unit comprises an assembly element and a damping element. The assembly element is disc-shaped with a central second through opening and an identical detent structure extends from a first side of each assembly element. The damping element is disc shaped with a central third through opening and arranged at least partially in the central second through opening of the assembly element. Due to this construction, the two fastening units can be fastened to one another by means of the mutually facing first sides having the identical detent structure of the respective mounting elements with first component arranged between them.

These fastening arrangements with damping effect all share the high effort in terms of assembly in production.

Based on these known fastening arrangements with damping effect or damping arrangements, respectively, an object of at least some implementations of the present disclosure is to provide an improved damping arrangement that is supposed to be fastenable without any tool and to be used with different material thicknesses. Another object of at least some implementations of the present disclosure is to suggest a corresponding connection method as well as production method.

### SUMMARY

The above object is solved by a damping arrangement, a first component with the damping arrangement, a component connection, a connecting method as well as a production method. Advantageous embodiments and further developments arise from the following description, the drawings as well as the appending claims.

A damping arrangement is fastenable in an opening of a first component. Furthermore, a dampened connection of the first component with a second component can be realized with the damping arrangement. The damping arrangement may include exclusively, two structurally identical damping elements, wherein each damping element includes: a head portion with a first outer diameter, a shaft portion with a second outer diameter that is smaller than the first outer diameter, the shaft portion extending from an underside of the head portion, as well as a central first through opening that is arranged within the shaft portion, with the shaft portion comprising a circumferential wall with a plurality of apertures so that the two structurally identical damping elements are fastenable to one another via the shaft portion by means of a form fit and/or friction fit connection wherein the undersides of the head portion are arranged facing each other and with the first component arranged therebetween.

Hereinafter, the use of the damping arrangement is explained for the better understanding of the disclosure. In this context, a main feature is that the damping arrangement consists of two structurally identical damping elements. Thus, the damping arrangement includes two components. A connection between the two damping elements is realized by means of the shaft portion designed as a circumferential wall with a plurality of apertures, causing the damping elements to be fastened to each other by means of a friction fit and/or form fit connection. Therefore, according to an alternative, no latching structures for fastening the damping elements in the opening of the first component are provided. In a second alternative, the shaft portion at the end which faces away from the head has a projection extending radially to the outside serving as a latching structure for fastening the damping element in the opening of the first component. In a further embodiment, the damping element is designed round or oval. Here, the oval design may realize a different damping in different directions.

For the spatial orientation, a longitudinal axis of the damping arrangement is defined by the central first through openings of the structurally identical damping elements. In other words, an insertion direction of a connecting element, as for example a connecting screw or a bolt, passes through the central first through openings of the structurally identical damping elements along the longitudinal axis of the damping arrangement.

In use, firstly, two identically constructed damping elements are provided which are intended to be fastened in an opening of a first component, e.g. an opening in an assembly flange of a vibration-generating pump or the like. Alternatively, the first component may also be a cord channel which is intended to be fastened to a vehicle body as an exemplary second component. An exemplary component thickness of the first component in the portion of the opening lies between 1 and 3 mm.

In a first step, one of the damping elements is provided which is arranged with the shaft portion in the opening of the first component. Here, the dimensioning of the length of the shaft portion is chosen so that in case of an abutment of the head portion to a first side of the first component, the end of the shaft portion which faces away from the head is at least flush with the opposite second side of the first component, which may reach beyond it. Accordingly, an outer diameter of the head portion is chosen big enough that the damping element abuts the first component adjacent to the first opening. The contact surface or attachment edge formed in this way defines a contact plane at the first component which is aligned rectangular to the longitudinal axis of the damping arrangement. In one embodiment, the contact surface or attachment edge is configured continuously. In an alternative configuration, the contact surface or attachment edge is configured partially, e.g. with apertures or the like. As on its outer side, the shaft portion may be configured cylindrically or oval, which may be without any latching features or the like, and may be neither arranged in a press fit in the component opening, the damping element which is arranged in the component opening is not arranged in there in a loss-proof manner. Rather, the first damping element may be arranged loosely in the component opening of the first component.

In order to restrict inserting the respective damping element into the opening in the first component, i.e. in order to reach a defined insertion depth, a radially outwardly reaching projection may be provided in the shaft portion at the outside adjacent to the underside of the head portion. This projection may be present continuously or with interruptions. Alternatively, this function may also be realized by providing two or more radially outwardly reaching projections which beside the contact surface or attachment edge of the head portion provide another contact surface at the component surface in the shaft portion.

As soon as the first of the two structurally identical damping elements has been arranged at the first component side with shaft portion extending into and through the opening in the first component, the other one of the two damping elements may be arranged in an analogous manner on the opposite second component side for the purpose of fastening the first damping element.

Due to the plurality of apertures present in the circumferential wall of the shaft portion, the circumferential wall comprises remaining wall segments between the apertures. An alignment of the first and the second damping element is now carried out so that the remaining wall segments of the first damping element engages the apertures in the shaft portion of the second damping element, and vice versa. In order to guarantee the spatially correct orientation of the two damping elements, the same may comprise a marking or labelling on an upper side of the head portion and/or on an end of the shaft portion facing away from the head.

As a result, one remaining wall segment of one damping element attaches at least one side, which may be both sides, on a remaining wall segment of the other damping element, respectively. Thus, the two structurally identical damping elements are fastened to each other via the shaft portion by means of a form fit and/or friction fit connection. In addition, the resulting damping arrangement is fastened in the opening of the first component in a loss-proof manner.

After the pre-assembly of the fastening arrangement which has been carried out in this manner, a second component is provided. This takes place at the same production location or at another production location, depending on the intended course of procedure. This is also explained in detail later.

An opening of the second component is aligned with the central first through openings of the damping elements. Subsequently, a connecting element as for example a connecting screw or a bolt, is guided through the central first through openings and fastened in a fastening portion which is provided in or adjacent to the second component. Here, the fastening may take place so that a compression of the respective damping element provides a damping effect both for axial as well as radial vibrations. In this context, a material selection for the damping element must be carried out in a way that on the one hand, a sufficient damping effect is provided while on the other hand, a necessary connecting stability is guaranteed at the same time. For this purpose, an elastomer or a thermoplastic elastomer may be suitable.

An advantage of this approach is that the effort in production is reduced due to the low number of components as well as due to the use of structurally identical damping elements. In order to facilitate the correct spatial assembly of the damping elements, the above-mentioned labelling or marking may be used. This leads to a reduction of the danger of a faulty assembly. Furthermore, an automated installation is facilitated.

Further advantages arise due to the apertures which are provided in the circumferential wall of the shaft portion. Thus, they allow that the damping element may be inserted more easily into the component opening of the first component due to a radially inwardly available elasticity of the remaining wall segments. This is explained later with reference to some embodiments.

Due to the apertures, the contact or abutment surfaces between the two structurally identical damping elements is furthermore enlarged in comparison with damping elements without apertures. The enlarged contact or abutment surface additionally provides for a clamping of the damping elements in the shaft portion so that a reliable anti-loss security is provided.

Due to the length of the shaft portion, the fastening of the damping arrangement in the first component is further improved, because the complete penetration of the shaft portion through the opening in the first component may lead to a safe retention of the damping arrangement in the opening in the first component.

In a further embodiment of the damping arrangement, each aperture extends in an axial direction from an end of the shaft portion which faces away from the head in the direction of the underside of the head portion, which may be up to the underside of the head portion. In this way, the length of the apertures is maximized in an axial direction, having an advantageous effect on the friction fit connection between the shaft portions of the damping elements, because in this way, the contact surface or abutment surface is between the damping elements is further increased.

In a further advantageous embodiment of the damping arrangement, the apertures are evenly spaced from one another. Furthermore, the apertures include at least partially an extension in circumferential direction which is smaller than the circumferential extension of neighboring wall segments, so that the two structurally identical damping elements may be fastened to one another by means of a press fit, or the extension corresponds to a circumferential extension of neighboring wall segments of the circumferential wall of the shaft portion. By means of the second alternative, the damping elements may be fastened to one another in a form fit or friction fit manner in case of apertures extending parallel to the longitudinal axis of the damping element or the damping arrangement. With regard to the first-mentioned alternative, a press fit may be achieved due to the design of the apertures and thus of the remaining wall segments, so that the friction fit connection may be configured stable.

In other words, this means that the necessary power for separating the damping elements is further increased compared to the second alternative.

Each aperture may have a circumferential extension adjacent to the underside of the head portion, which is greater than a circumferential extension at the end of the shaft portion which faces away from the head, so that an undercut is present in axial direction. The force which is necessary for separating the damping elements may be further increased by that. This has also a positive effect on the fastening of the damping elements in the component opening of the first component.

On the radial outside, each damping element may include a projection in the head portion which extends parallel to the shaft portion. This projection serves as a contact surface at the component upper side adjacent to the opening of the first component. For increasing the stability in the head portion of the damping element, in connection with this embodiment that between the shaft portion and the projection, a plurality of ribs may be provided on the underside of the head portion.

In an advantageous embodiment, the damping arrangement furthermore only includes one sleeve with a central second through opening, arranged at least partially in the central first through opening of each damping element by means of a friction-fit connection and/or substance-to-substance bond/firm bond, so that the two structurally identical damping elements may additionally be fastened to one another by means of the only one sleeve. Here, a main feature is that the damping arrangement now consists of two structurally identical damping elements as well as only one sleeve. The damping arrangement thus comprises three parts, which may be exclusively three parts. A connection between the two damping elements is supported by holding the only one sleeve in the central first through opening of each damping element by means of a friction-fit and/or firm bond. Therefore, no latching structures may be provided for fastening the damping elements in the opening of the first component.

When using this embodiment, one of the damping elements with the only one sleeve that is at least partially arranged in the central first opening may be provided in a first step. For this purpose, the only one sleeve is inserted into the central first through opening, which may be from the end of the shaft portion facing away from the head so that the only one sleeve is arranged at least partially in the central first through opening. Due to the friction-fit and/or firm arrangement of the only one sleeve in the central first through opening, the same is fastened there in a loss-proof manner. Part of the only one sleeve may project from the shaft portion of the first damping element.

The correspondingly prepared first damping element with the only one sleeve extending beyond the shaft portion is now arranged in the opening of the first component. After that, the other one of the two damping elements is, as described in the beginning, arranged at the opposite second component side in a way that the remaining wall segments at least partially engage each other. In this way, the free end of the only one sleeve, e.g. the part extending beyond the shaft portion of the first damping element, is additionally fastened in the central first through opening of the second damping element by means of a friction fit and/or firm bond. In this way, the resulting damping arrangement may be fastened loss-proof in the opening of the first component.

The only one sleeve may have an axial length that is larger than the axial length of one damping element but shorter than the axial length of two damping elements. This ensures that a compression of the respective damping element can provide a damping effect both for axial as well as radial vibrations. In addition, when using the only one sleeve, a choice of material for the damping element may be aimed more towards the damping effect as the stability of the damping arrangement that is reduced by that can be compensated by the stabilizing effect of the only one sleeve. The only one sleeve may be made of metal or a thermoplastic material.

In a further embodiment of the damping arrangement with the only one sleeve, each damping element comprises a plurality of radially inwardly projecting protrusions in the central first through opening, which realize the friction fit connection with the only one sleeve. In this way, the only one sleeve is arranged by means of a press fit in the central first through opening of the respective damping element. During the assembly, firstly, the only one sleeve can then be fastened in a first of the two damping elements in a loss proof manner. This first or prepared damping element with the only one sleeve fastened therein in a loss proof manner may then be inserted with the projecting part of the only one sleeve and the shaft portion into the opening in the first component from one side. When plugging-on the remaining second damping element from the opposite component side into the opening in the first component, the same is also fastened on the only one sleeve in a loss-proof manner. Thus, processing of the respective damping arrangement is made easier and an automatic processing may be supported.

In a further embodiment of the damping arrangement, the central first through opening comprises, adjacent to an upper side of the head portion, a projection which projects radially to the inside. This projection may serve for forming an axial, partial, contact surface or attachment rim for the only one sleeve when the damping arrangement is used with the only one sleeve. In this way, it is guaranteed that the only one sleeve is inserted up to a defined position into the central first through opening. With respect to a round, central first through opening, the same has an inner diameter adjacent to the upper side of the head portion that is smaller than the outer diameter of the only one sleeve. This reduction of the inner diameter adjacent to the upper side of the head portion is carried out for example by means of a step, a chamfer or a combination thereof. The corresponding projection may be configured continuously or with interruptions. Alternatively, and with regard to a central first through opening that is configured non-round in combination with a non-round sleeve, the corresponding contact surface or attachment rim can be formed by a projection which protrudes radially inwardly with respect to the longitudinal axis of the damping element. In this case, the contact surface or attachment rim is also provided by means of a step, a chamfer or a combination thereof. Providing a chamfer in order to provide a contact surface or attachment rim for the only one sleeve has the advantage that in later use, the behavior of the damping element is improved in case of a compression, which may be shearing-off material from the damping element by the only one sleeve is avoided.

Advantageously, each damping element has a shore A hardness between 40 to 80 shore A. This embodiment may cause the damping element to comprise damping effects which are adapted to the respective area of use.

A first component has a damping arrangement that is arranged in a component opening of the first component. The first component is for example a pump, such as a vacuum pump, with the damping arrangement being preassembled in an opening of an assembly flange. As an alternative to the pump, the first component may also be a cord channel or something similar, which is intended to be fixed with a dampened bearing to, for example, a vehicle body as the second component. A material thickness of the first component adjacent to the component opening may lie between 1 and 3 mm. With respect to the resulting technical effects and advantages, reference is made to the above explanations regarding the damping arrangement in order to avoid repetitions.

In this context, the shaft portion may have a length which is chosen in a way that when the head portion abuts a side of the first component, the end of the shaft portion which faces away from the head is flush at least with the opposite side of the first component, which may project same. In doing so, a secure fastening of the damping elements to one another may be provided.

A component connection includes a first component as well as a second component with a second opening and a connecting element, wherein the connecting element extends through the damping arrangement and is in engagement with a matching fastening portion in or adjacent to the second component. This construction clearly shows that a releasable fixation, e.g. a screwing, may be implemented with the damping arrangement.

Where the damping arrangement is used with the only one sleeve, it may be of advantage that the only one sleeve of the damping arrangement attaches the components in the firmly bonded state of the two components in a manner that a screwing-on-block may be realized. It follows from that that a length or axial extension of the only one sleeve in longitudinal direction of the damping arrangement may be less than an axial extension of the damping elements in longitudinal direction of the damping arrangement. With respect to the component connection, too, reference is made to the above explanations regarding the damping arrangement.

In a further embodiment of the component connection, a radial tolerance compensation during establishing the component connection may be realized in that the only one sleeve has an inner diameter that is larger than the outer diameter of the connecting element. By that, the fastening of the two components to each other may be facilitated, be it by a worker or automatically.

Finally, in case of a likewise embodiment of the component connection, the connecting element includes a head and a shaft and a disc is provided between the head of the connecting element and the damping element of the damping arrangement arranged adjacent to it, wherein an outer diameter of the disc is larger than an inner diameter of the opening in the first component. By that, the fastening force does not only have an effect on the damping arrangement but also on the first component. Furthermore, the disc that is dimensioned in this way prevents the first component from completely releasing from the second component in case of a failure of the damping arrangement.

A connecting method of a first component with a second component includes the steps: providing a first component or providing a first component and a damping arrangement as well as arranging the damping arrangement in an opening of the first component, after that, arranging a second component with a second component opening in alignment with the first component opening and inserting the connecting element so that the connecting element engages a suitable fastening portion in or adjacent to the second component. Thus, the component connection may be established with the connecting method. With regard to the arising technical effects and advantages, reference is therefore made to the above explanations.

A production method of a damping arrangement includes the steps: providing two structurally identical damping elements, arranging the two damping elements in a way that the end, which faces away from the head, of the shaft portion of the first damping element faces the end, which faces away from the head, of the shaft portion of the second damping element, and fastening the two damping elements with each other so that the two structurally identical damping elements with mutually facing undersides of the head portion with a first component being arranged therebetween, are fastenable with each other via the shaft portion by means of a form fit and/or friction fit connection. As can be recognized from the above steps, the damping arrangement may be provided by means of the exemplary production method. To avoid repetitions, reference is therefore made to the above explanations in connection with the damping arrangement.

The material of the damping element may have a shore A hardness between 40 and 80 shore A. This configuration may ensure that the damping element has damping features which are adapted to the respective application field.

Furthermore, the production method may include the further steps: providing only one sleeve and arranging the only one sleeve in one of the two structurally identical damping elements first and after that in the remaining damping element so that the two structurally identical damping elements with a first component arranged therebetween are additionally fastenable to each other by means of the only one sleeve. By that, the fastening of the damping elements to each other is further supported. In addition, the use of the only one sleeve may have a positive effect on the later to be established connection between the first and the second component, something that has already been discussed above.

In a further embodiment of the production method, the sleeve may be made of a metal or a thermoplastic. The sleeve may be made of an electrically conductive material, which may be of an electrically conductive thermoplastic with or without fiber reinforcement. The damping arrangement is adapted to the desired application field by selecting the respective material.

In a further embodiment of the production method, the providing of one of the two structurally identical damping elements may take place by overmolding the only one sleeve with a material of the damping element. By means of this approach, the only one sleeve is overmolded by the damping element when injection-molding same. In this context, the damping element may be produced by means of vulcanization or extrusion instead of injection-molding. In this context, the only one sleeve may comprise a plurality of apertures. In this way, the only one sleeve may be fastened securely to one of the damping elements.

### BRIEF DESCRIPTION OF THE DRAWINGS

In the following, the present disclosure will be described in detail with reference to the drawings. In the drawings, the same reference signs refer to the same components and/or elements. They show:

FIG. 1 a perspective view of a damping element from above,

FIG. 2 a perspective view of the damping element of FIG. 1 from below,

FIG. 3 a lateral view of the damping element of FIG. 1,

FIG. 4 a sectional view of the damping element of FIG. 1,

FIG. 5 a top view on the damping element of FIG. 1,

FIG. 6 a view of the damping element of FIG. 1 from below,

FIG. 7 an embodiment of the damping arrangement with the damping element according to FIG. 1,

FIG. 8 a perspective view of the embodiment of the damping arrangement according to FIG. 7 in the assembled state with partial cut through the upper damping element,

FIG. 9 a sectional view of the embodiment of the damping arrangement according to FIG. 7 in the assembled state in the portion of the shaft portions,

FIG. 10 a sectional view of an embodiment of a first component with damping arrangement according to FIG. 7 arranged in there,

FIG. 11 a sectional view of an embodiment of a component connection,

FIG. 12 a perspective view of an alternative damping element from below,

FIG. 13 a sectional view of the damping element of FIG. 12,

FIG. 14 a sectional view of the damping element of FIG. 12 with sleeve inserted in there,

FIG. 15 an alternative embodiment of the damping arrangement with the damping element according to FIG. 12,

FIG. 16 a sectional view of a further alternative damping element,

FIG. 17 a flow chart of an exemplary connecting method, and

FIG. 18 a flow chart of an exemplary production method of a damping arrangement.

### DETAILED DESCRIPTION

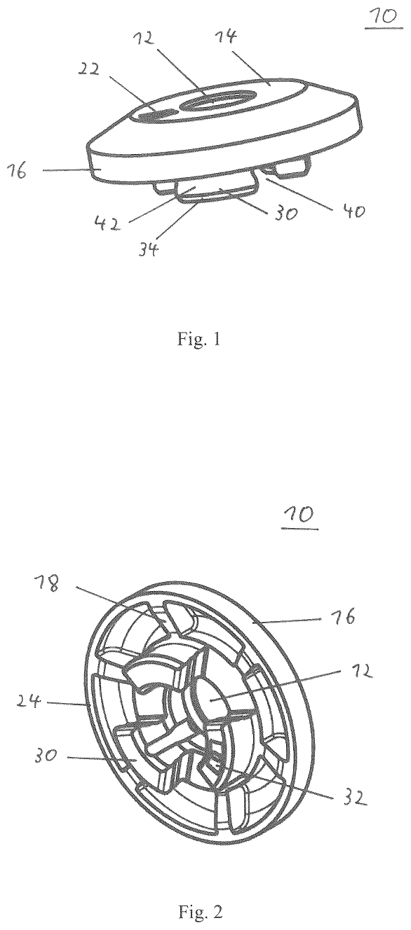

An embodiment of a damping arrangement 1 is comprised of two structurally identical damping elements 10. Further components or elements for securing the damping arrangement 1 in an opening of a first component A may not be necessary. For supporting the proper functioning of the damping arrangement 1, still only one sleeve 50 is present in the illustrated embodiment. For the better comprehensibility, an embodiment of a damping element 10 is explained first with reference to FIGS. 1 to 6.

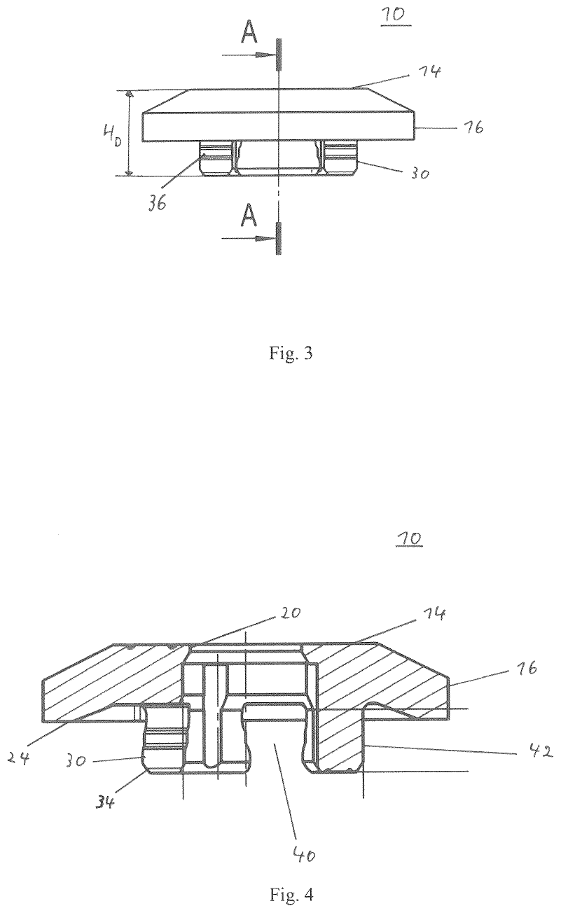

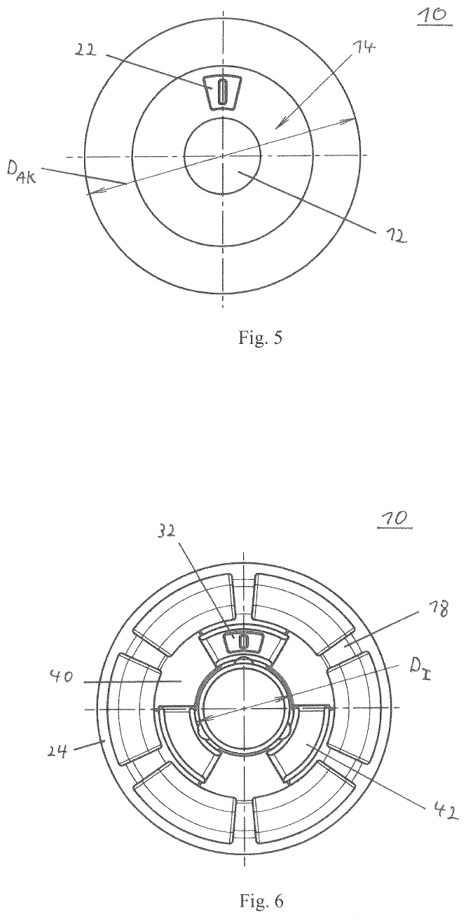

The damping element 10 may be formed disc-like and has a central first through opening 12 with an inner diameter Di, a head portion 14 as well as a shaft portion 30. In a known way, the head portion 14 comprises an upper side as well as an underside and has an outer diameter D_{AK} (see FIG. 5). From the underside of the head portion 14, the shaft portion 40 extends with an outer diameter, therefore having one end facing the head and one end facing away from the head. A first axial end of the damping element 10 is therefore defined by the upper side of the head portion 14 and a second axial end of the damping element 10 is defined by the end of the shaft portion 30 which faces away from the head. An axial height HD of the damping element 10 is measured between the upper side of the head portion 14 adjacent to the central first through opening 12 and the second axial end, as is shown in FIG. 3.

Adjacent to the through opening 12, the upper side of the head portion 14 is formed plane. In this area, a marking or labelling 22 is provided, which supports a spatially correct orientation during the later assembly of a second damping element 10. In the further course to the radial outside, the head portion 14 is configured inclined in the direction of the shaft portion 30. At the end of this inclined portion, there is a projection 16 which extends parallel to the longitudinal axis or shaft portion 30 of the damping element 10 from the upper side in the direction of the end of the shaft portion 30 which faces away from the head. As can be seen later, an underside of this projection 16 which may serve as a contact surface 24 at the first component A adjacent to the opening in the first component A. Furthermore, ribs 18 for reinforcing the head portion 14 and thus the damping element 10 are provided at the underside of the head portion 14. In the present example, six ribs 18 are provided, as can be seen in FIG. 2, which are arranged evenly spaced from one another. For the better comprehensibility of the construction, FIG. 4 shows a sectional view of the damping element 10, with the cut having been made through the ribs.

As has already been mentioned above, the shaft portion 30 extends from the underside of the head portion 14. The shaft portion 30 comprises a circumferential wall with a plurality of apertures 40 so that it has a cylindrical shape on the outside. In the illustrated embodiment, there are three evenly spaced apertures 40 so that there is a remaining wall segment 42 of the circumferential wall between two apertures 40. Furthermore, the apertures 40 extend from the end of the shaft portion 30, which faces away from the head, up to the underside of the head portion 14. This design, may facilitate the later inserting of the damping element 10 into a component opening of the first component A, as the remaining wall segments 42 may elastically yield radially to the inside.

As can be seen in FIG. 4, each aperture 40 has a circumferential extension adjacent to the underside of the head portion 14 which is larger than a circumferential extension at the end of the shaft portion 30 which faces away from the head. In other words, the apertures 40 taper from the underside of the head portion 14 in the direction of the end of the shaft portion 30 facing away from the head. Therefore, with respect to the remaining wall segment 42 of the circumferential wall, they taper in the reverse direction, i.e. from the end of the shaft portion 30 which faces away from the head in the direction of the underside of the head portion 14. In this way, an undercut results in axial direction, the significance of which becomes clear when using the damping arrangement 1.

In the illustrated embodiment, the lateral faces, which arise due to the apertures 40, of the remaining wall segments 42 are configured with multiple steps. This can be seen in FIGS. 3, 4, 7 and 8. A stable form fit and friction fit connection between two damping elements 10 which may be fastened to one another is established by that.

Alternatively or additionally to this design, the apertures 40 may also be designed in a way that in circumferential direction, they have at least partially an extension which is smaller than the circumferential extension of adjacent remaining wall segments 42, so that later, when assembling two structurally identical damping elements 10 to form a damping arrangement, the two structurally identical damping elements 10 may be fastened to each other by means of a press fit. The friction fit connection may be strengthened by that compared to a design where the circumferential extension of the apertures 40 corresponds to the circumferential extension of adjacent, remaining wall segments 42 of the circumferential wall of the shaft portion 30.

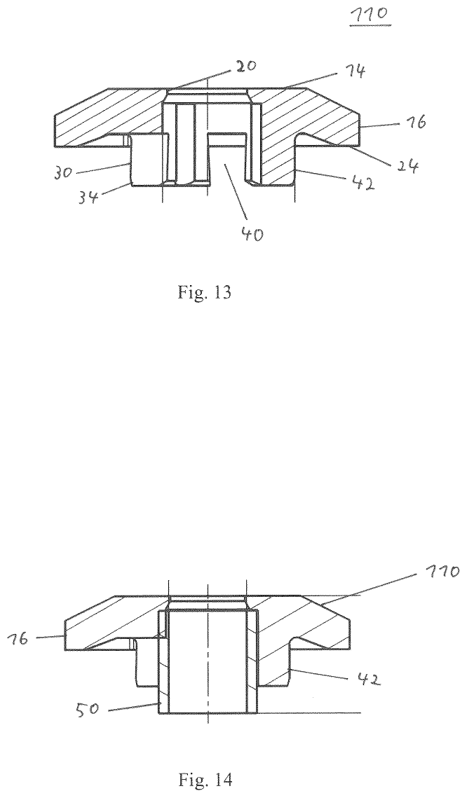

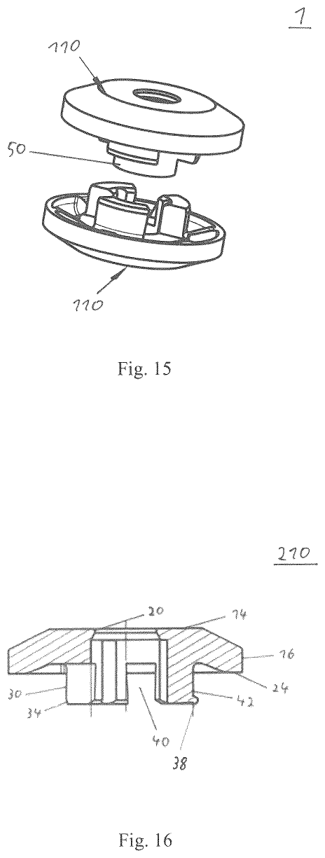

For the better comprehensibility, these two embodiments are explained on the basis of apertures 40, which do not taper and/or are not configured with multiple steps but extend continuously parallel to the longitudinal axis of the damping element 10. A corresponding alternative configuration of a damping element 110 is shown in FIGS. 12 to 15, which are additionally referred to. However, the statements apply analogously for tapering apertures 40. In case the circumferential extension of the apertures 40 and of the remaining wall segments 42 are the same, a form fit is provided when two structurally identical damping elements 10 are assembled. Furthermore, a remaining wall segment 42 of one damping element 10 attaches two remaining wall segments 42 of the other damping element 10 so that a friction fit connection is established. This friction fit connection may be strengthened by choosing a smaller circumferential extension of the apertures 40 compared with the circumferential extension of the remaining wall segments 42. In this context, these views always refer to the same plane perpendicular to the longitudinal axis of the damping element 10 or the damping arrangement 1.

Furthermore, the shaft portion 30 includes a chamfer 34 at the end which faces away from the head, as is shown in FIG. 4. The chamfer 34 serves for the facilitated inserting of the damping element 10 into the opening in the first component A. In addition, a marking or labelling 32 is available at the end of the shaft portion 30 which faces away from the head. The same supports the correct alignment of the damping elements 10 to each other during the assembly, as does the marking or labelling 22 on the upper side of the head portion 14.

In addition, and with reference to FIGS. 3 and 4, the damping element 10 includes one or more latching noses 36. The latching noses 36 serve for increasing the friction value when the damping element 10 is used. This may have a positive effect when the circumferential extension of the remaining wall segments 42 and of the apertures 40 is the same. It should be noted in this context that for clarity reasons, the latching noses 36 are only shown in FIGS. 3 and 4.

The central first through opening 12 may comprise projections in the shaft portion 30. By means of the projections, a reduction of an inner diameter Di of the central first through opening 12 is achieved so that a sleeve 50 which is later inserted into the shaft portion 30 may be fastened in there in a friction-fit and thus loss-proof manner.

Adjacent to the upper side of the head portion 14, the damping element 10 additionally includes a portion 20 with reduced inner diameter. The portion 20 with decreased inner diameter, in case of a central first through opening 12 that is configured round, may be provided by means of a step, a chamfer or a combination thereof. In FIG. 4, the portion 20 with reduced inner diameter is provided by means of a conical transition. The further advantage of that is that in case of a compression of the damping element 10, the danger that this portion of the damping element 10 is shorn off by the only one sleeve 50 is reduced. In this context, it should generally be noted that beside the completely circumferential design of the portion 20, the same effect may be achieved by means of interrupted projections or the like, as long as a limitation of the insertion depth for the only one sleeve 50 is provided.

Due to the outer diameter D_{AK} of the head portion, which is larger than a diameter of the opening in the first component A, it is guaranteed when using the damping element 10 that the respective damping element 10 does not fit through the opening in the first component A but attaches the edge portion of the opening. Thus, in use, the underside of the head portion 14 is arranged adjacent to the first component A. In the later component connection, the opposite upper side of the head portion 14 is arranged adjacent to a connecting element such as a connecting screw 3 or an associated disc 5, respectively. In this state, the shaft portion 30, the outer diameter of which may correspond to the diameter of the opening in the first component A, extends into the opening in the first component A at least to an extent that the end of the shaft portion 30 which faces away from the head is flush with the opposite side of the first component A, it may extend beyond it.

For providing the desired damping function by the damping element 10, the same may be made of an elastomer or a thermoplastic elastomer having a shore A hardness between 40 and 80 shore A. The damping element 10 and thus the damping arrangement 1 may overall be adapted to the desired application field by means of the corresponding choice of the material. Possible application fields lie within a temperature range between −40° C. and 200° C.

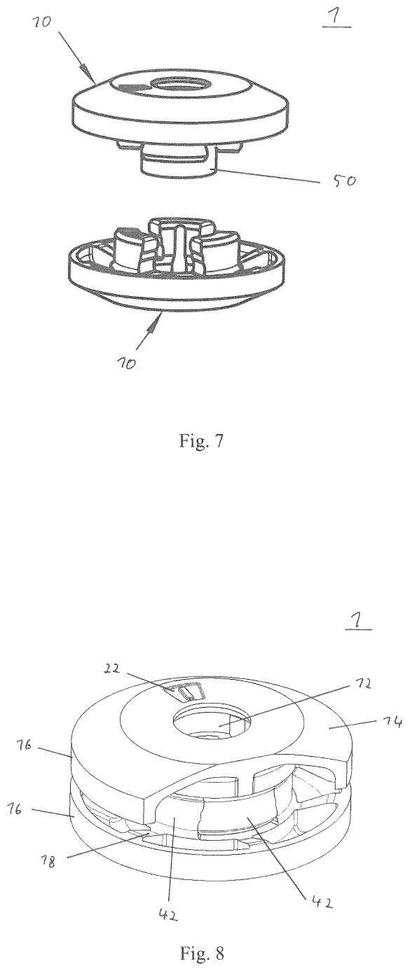

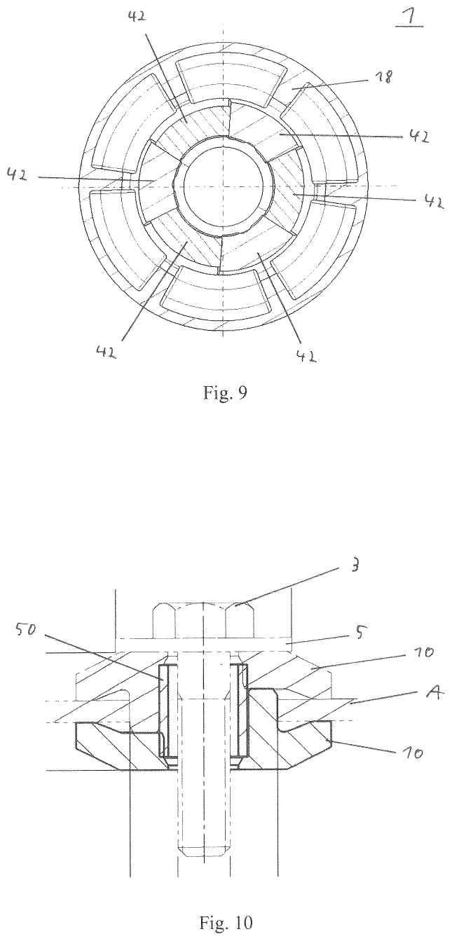

A damping arrangement 1 is now shown with respect to FIGS. 7 to 9, with FIG. 7 showing same in the non-assembled state. FIGS. 8 and 9 emphasize the assembled state, for reasons of clarity without first component A. In use, the only one sleeve 50 is at least partially arranged in the central first through opening 12 of the damping elements 10, with the arrangement of the sleeve 50 taking place by means of a friction fit connection and/or firm bond, as has been discussed above.

An axial extension or height of the sleeve 50 in longitudinal direction of the damping element 10 is at least the same of and may be more than an axial height HD of the damping element 10. In order to keep the damping properties, the axial height of the only one sleeve 50 is, however, less than twice of the axial height HD of the damping element 10 minus half of the length of the apertures 10. If the portion 20 is available with a decreased inner diameter, the axial height of the sleeve 50 may be the same as twice of the distance between the step formed by the portion 20 with decreased inner diameter and the position at half of the length of the remaining wall segments 42. In this way in case of a later screwing on block where the only one sleeve 50 abuts the second component B on the one hand as well as the connecting screw 3 or the associated disc 5, respectively, a compression of the damping elements 10 in the longitudinal direction of the damping element 1 may be realized.

A metal or thermoplastic is used as the material for the sleeve 50. The material may be an electrically conductive material, e.g. a thermoplastic material with electrically conductive properties and with or without fiber reinforcement. As during the later use, the only one sleeve 50 attaches the second component on the one hand and a fastening element, such as a connecting screw or a corresponding disc 5 on the other hand, the material is selected so that the sleeve 50 may assume and transmit the arising forces.

A secure assembling of the damping arrangement 1 in the component opening of the first component A takes place via the shaft portion 30, configured with the apertures 40, of the damping elements 10. The reason for that is that due to the interaction and mutual engagement of the shaft portions 30 of two structurally identical damping elements 10, the same are retained to one another via the shaft portions 30 by means of a form fit and/or friction fit connection. Thus, the two damping elements 10 are fastened to each other in a loss-proof manner. In this context, the apertures, may provide an enlarged abutment or contact surface for the remaining wall segments 42, so that the retention of the damping elements 10 to each other is improved.

This fastening may be further supported by means of the only one sleeve 50, which is at least partly arranged in the shaft portion 30 of each damping element 10. This is realized by providing the radially inwardly protruding projections in the central first through opening 12, which may be in the shaft portion 30. This ensures that the parts damping element 10 and sleeve 50 are fastened to each other in a loss-proof manner. In addition and which may be in case of a preassembly of a sleeve 50 in a damping element 10 before arranging the damping element 10 in the opening of the first component A, the further processing can be facilitated and the damping arrangement 1 may be processed automatically.

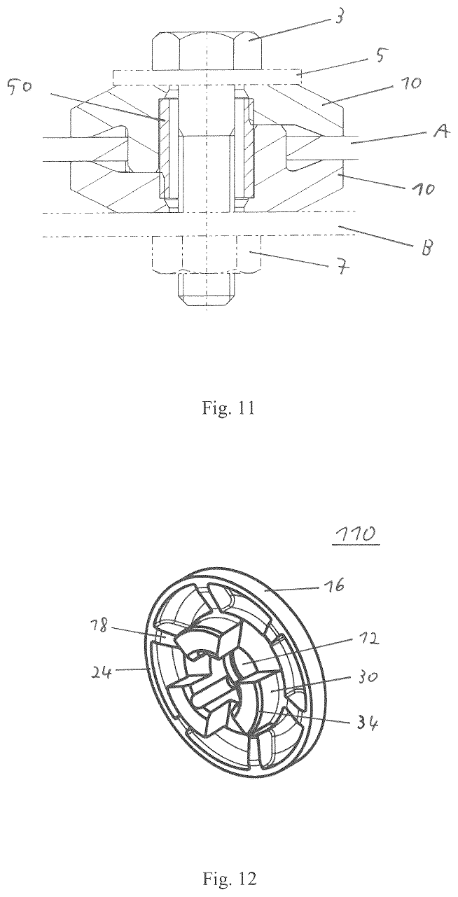

With reference to FIGS. 10 and 11, the establishing of a component connection by means of the damping arrangement 1 is explained. For doing so, firstly, two structurally identical damping elements 10 are provided which are intended to be fastened in an opening of a first component A, e.g. an assembly flange of a vibration-generating pump or cable channel. A material thickness of the first component A adjacent to the component opening may lie between 1 and 3 mm. If the only one sleeve 50 is used, the only one sleeve 50 is arranged in one of the damping elements 10 in a first step, provided none of the damping elements 10 already comprises the only one sleeve 50. After that, the damping element 10 which has been prepared in this way with the only one sleeve that is at least partially arranged in it is arranged adjacent to the opening of the first component A. Here, the dimensioning of the outer diameter of the shaft portion of the damping element 10 with respect to the opening in the first component A is such that the shaft portion 30 of the damping element 10 extends into the opening in the first component A. The length of the shaft portion 30 may be chosen such that the end of the shaft portion 30 which faces away from the head protrudes at the opposite side of the first component A or is at least flush with this side. This may guarantee a secure fastening in the opening in the first component A, which may be when it interacts with the second damping element 10.

In turn, the outer diameter D_{AK} of the damping element 10 in the head portion is chosen such that the damping element 10 abuts the first component A adjacent to the first opening. The contact surface 24 which is formed in this way defines a contact plane at the first component A which is perpendicular to the longitudinal axis of the damping arrangement 1.

Once one of the two structurally identical damping elements 10 with shaft portion 30 extending into the opening in the first component A has been arranged at a first component side, the other one of the two structurally identical damping elements 10 is arranged in an analogous manner at an opposite second component side. Both damping elements 10 are constructed in the same way. Therefore, the remaining wall segments 42 of the one damping element 10 engage the apertures 40 of the other damping element 10, so that a form fit and/or friction fit connection between the damping elements 10 is established. The first component A may be arranged between the damping elements 10 and between the head portions 14.

An advantage of this approach is that the effort of establishing the component connection is reduced as two structurally identical damping elements 10 are used. Furthermore, a worker does not have to pay attention to a correct assignment of the damping elements 10, which may be in case the only one sleeve 50 is not preassembled in a damping element 10. Therefore, the danger of a faulty assembly is reduced by that, too. In addition, the option of automized assembly is provided. As a result, the two damping elements 10 are therefore fixable to each other due to the design of the shaft portion 30 with first component A therebetween alone. That means that in this state, a first component A with a preassembled damping arrangement 1 is available in a component opening of the first component A.

After the preassembly of the damping arrangement 1 which has been carried out in this way, a second component B is provided. This takes place at the same production location or at another production location, depending on the desired course of the procedure.

An opening of the second component B is aligned with the central first through opening 12 of the damping elements 10. After that, a connecting screw 3 as connecting element is guided through the central first through openings 12 and brought into engagement with a fastening portion 7 for the connecting screw 3, with the fastening portion 7 for example including an inner thread and being provided in or adjacent to the second component B. A radial tolerance compensation may be realized for example and when using the only one sleeve 50 in that even in the portion 20 with reduced inner diameter, the only one sleeve 50 has an inner diameter that is larger than the outer diameter of the connecting screw 3. By that, the fastening of the two components A, B to each other may be facilitated, be it by a worker or automatically.

An exemplary screwing when using the damping arrangement 1 with the only one sleeve 50 takes place so that in an initial state, the only one sleeve 50 abuts an axial undercut in the central first through opening 12. When the connecting screw 3 is now screwed tight in the second component, a compression of the respective damping element 10 provides a damping effect both for axial as well as radial vibrations. This construction clearly shows that a releasable screwing may be realized with the damping arrangement 1, wherein in the firmly connected state of the two components A, B, the only one sleeve 50 may abut the second component on the one hand and on the other hand the connecting screw 3 or the associated disc 5, respectively, so that a screwing on block is present. The use of a disc 5 with an outer diameter being greater than the diameter of the opening in the first component may have proven advantageous in this context. The reason is that in this way, the first component A does not detach from the second component B, even in case of a failure of the damping arrangement 1. In addition, the forces which are applied on the damping arrangement due to the screwing are distributed more evenly.

FIGS. 12 to 15 show an alternative embodiment of a damping element 110 and its use in a damping arrangement 1. The damping element 110 differs from the above discussed damping element 10 in that the apertures 40 do not form any undercut. Rather, the apertures 40 extend parallel to the longitudinal axis of the damping element 110 and do not taper. Apart from that, the damping element 110 corresponds to the damping element 10. Therefore, reference is made to the above explanations in terms of the structure as well as the technical effects and advantages achievable by that.

FIG. 16 shows another alternative embodiment of a damping element 210. At the end of the shaft portion 30 which faces away from the head, this damping element 210 has a projection 38 which projects radially to the outside. It provides a latching structure which serves for fastening the damping element 210 in the opening of the first component A. In the assembled state of the damping arrangement 1, the projection 38 of a damping element 210 is therefore located at the same component side as the contact surface 34 of the other damping element 210. In doing so, the fastening of the damping element 210 and thus of the damping arrangement 1 in the component opening of the first component A is further improved. Apart from that, the construction of the damping element 210 corresponds to the construction of the damping element 110.

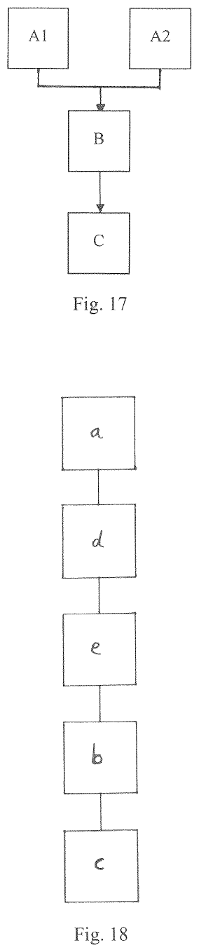

Reference is now made to FIG. 17, explaining an embodiment of a connecting method of a first component A with a second component B. Here, a first component A with damping arrangement 1 arranged in there is provided in a first step A1. In an alternative first step A2, a first component A and a damping arrangement 1 are provided and the damping arrangement 1 is arranged in an opening of the first component A. In the subsequent second step B, a second component B having a second component opening is arranged such that the second component opening is aligned with the first component opening. Finally, the connecting screw 3 is inserted in step C, so that the connecting screw 3 engages a fastening portion 7 in or adjacent to the second component B.

Finally and with respect to FIG. 18, a schematic course of procedure of a production method of a damping arrangement 1 is shown. Here, two structurally identical damping elements 10; 110; 210 are provided in a first step a. As the material for the damping elements 10; 110; 210, a material with a shore A hardness between 40 and 80 shore A may be used as a material. In the subsequent step b, the two damping elements 10; 110; 210 are arranged such that the end of the shaft portion 30, which faces away from the head, of the one damping element 10; 110; 210 faces the end of the shaft portion 30, which faces away from the head, of the other damping element 10; 110; 210. In step c, the two damping elements 10; 110; 210 which have been aligned in this way, are now fastened to each other. Thus, two structurally identical damping elements 10; 110; 210 with undersides facing one another of the head portion 14 with first component A arranged therebetween are fastenable to each other via the shaft portion 30 by means of a form fit and/or friction fit connection.

Before, at the same time or after providing the structurally identical damping elements in step a, providing the only one sleeve 50 takes place in step d and arranging the only one sleeve in one of the damping elements 10; 110; 210 and after that in the remaining damping element 10; 110; 210 takes place in step e. In this way, the two structurally identical damping elements 10; 110; 210 are fastenable to each other by means of the only one sleeve 50.

The providing of the damping elements 10; 110; 210 in step a can take place by means of injection molding the damping elements 10; 110; 210. Alternatively, the damping elements 10; 110; 210 may also be produced by means of vulcanization or extrusion. Generally, different approaches are possible. On the one hand, the damping elements 10; 110; 210 and the only one sleeve 50 may be provided separately from one another so that an inserting of the only one sleeve 50 into one of the damping elements 10; 110; 210 first and after that into the remaining damping element 10; 110; 210 takes place in step c.

Alternatively, the only one sleeve 50 is arranged in an injection mold and one of the two damping elements 10; 110; 210 is produced by means of injection molding, i.e. the only one sleeve 50 is overmolded accordingly. In this way, the only one sleeve 50 is directly arranged at the correct position in the damping element 10; 110; 210, so that the separate arranging of the only one sleeve 50 in the damping element 10; 110; 210 is omitted. This facilitates the production method further. In case the sleeve 50 is supposed to be made of a thermoplastic, it may also be produced by means of injection molding. In this context, the only one sleeve 50 may be produced in the same tool, so that the damping element 10; 110; 210 with the only one sleeve 50 in there is producible in a 2K injection molding.

The second damping element 10; 110; 210 is also produced by means of injection molding, wherein there is no sleeve in the injection mold. In this case, an assembly may take place such that the damping element 10; 110; 210 with the only one sleeve 50 preassembled in there is arranged at least partly in the component opening, until the underside of the head portion 14 attaches the component upper side. The remaining damping element 10; 110; 210 is then plugged into the component opening from the other side of the first component A, causing the second damping element 10; 110; 210 to come into engagement with the only one sleeve 50, too, and the underside of the head portion 14 of the second damping element 10; 110; 210 abuts the opposite component upper side of the first component A.

In a further embodiment of the production method, the sleeve 50 is made of a metal or a thermoplastic. The sleeve 50 may be made of an electrically conductive material, which may be of an electrically conductive thermoplastic with or without fiber reinforcement. By selecting the corresponding material, the damping arrangement 1 is adapted to the required application field.

1. A damping arrangement which is fastenable in an opening of a first component and by which a dampened connection of the first component with a second component are realizable, comprising
a. two structurally identical damping elements, wherein each damping element includes:
a1. a head portion with a first outer diameter,
a2. a shaft portion with a second outer diameter that is smaller than the first outer diameter and extends from an underside of the head portion, as well as
a3. a central first through opening that is arranged within the shaft portion, with
b. the shaft portion comprising a circumferential wall with a plurality of apertures so that
c. the two structurally identical damping elements are fastenable to one another via the shaft portion by means of a form fit and/or friction fit connection wherein the undersides of the head portion are arranged facing each other and with the first component arranged therebetween.

2. The damping arrangement according to claim 1, wherein each aperture extends in axial direction from an end of the shaft portion which faces away from the head in the direction of the underside of the head portion.

3. The damping arrangement according to claim 1, wherein the apertures are evenly spaced from one another.

4. The damping arrangement according to claim 1, wherein in circumferential direction, the apertures include at least partially an extension which
a) is smaller than the circumferential extension of neighboring wall segments, so that the two structurally identical damping elements are fastenable to one another by means of a press fit, or
b) corresponds to a circumferential extension of neighboring wall segments of the circumferential wall of the shaft portion.

5. The damping arrangement according to claim 1, wherein each aperture has a circumferential extension adjacent to the underside of the head portion, which is greater than a circumferential extension at the end of the shaft portion which faces away from the head, so that an undercut is present in axial direction.

6. The damping arrangement according to claim 1, where each damping element includes a projection in the head portion on the radial outside, wherein the projection extends parallel to the shaft portion.

7. The damping arrangement according to claim 6, wherein between the shaft portion and the projection, a plurality of ribs is provided on the underside of the head portion.

8. The damping arrangement according to claim 1, which furthermore includes only one sleeve with a central second through opening arranged at least partially in the central first through opening of each damping element by means of a friction-fit connection and/or firm bond, so that the two structurally identical damping elements are additionally fastenable to one another by means of the only one sleeve.

9. The damping arrangement according to claim 8, wherein each damping element comprises a plurality of radially inwardly projecting protrusions in the central first through opening, which realize the friction fit connection with the only one sleeve.

10. The damping arrangement according to claim 1, wherein the central first through opening comprises, adjacent to an upper side of the head portion, a projection which projects radially to the inside.

11. The damping arrangement according to claim 1, wherein each damping element has a shore A hardness between 40 to 80 shore A.

12. A first component having a damping arrangement according to claim 1 that is arranged in a component opening of the first component.

13. The first component according to claim 12, wherein the shaft portion has a length which is chosen in a way that when the head portion abuts a side of the first component, the end of the shaft portion which faces away from the head is flush at least with the opposite side of the first component.

14. A component connection including a first component according to claim 13 as well as a second component with a second opening and a connecting element, wherein the connecting element extends through the damping arrangement and is in engagement with a matching fastening portion in or adjacent to the second component.

15. The component connection according to claim 14, wherein a radial tolerance compensation are realizable in that the only one sleeve has an inner diameter that is larger than the outer diameter of the connecting element.

16. The component connection according to claim 14, where the connecting element includes a head and a shaft and a disc is provided between the head of the connecting element and the damping element of the damping arrangement that is arranged adjacent to it, wherein an outer diameter of the disc is larger than an inner diameter of the opening in the first component.
